(19) United States
(12) Patent Application Publication
(10) Pub. No.: US 2007/0247508 A1
(43) Pub. Date: Oct. 25, 2007

(54) Droplet ejection apparatus and identification code

(75) Inventor: Hirotsuna Miura, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/788,984

(22) Filed: Apr. 23, 2007

(30) Foreign Application Priority Data
Apr. 24, 2006 (JP) 2006-119562

(51) Int. Cl. B41J 2/01

(52) U.S. Cl. 347/102

(57) ABSTRACT

A droplet ejection apparatus that ejects liquid droplets containing metal ink onto a glass substrate includes a droplet ejection head, a transport device, a semiconductor laser, a reflective mirror, and a first shifting device. The droplet ejection head has a nozzle plate opposed to the substrate. The droplets are ejected from a nozzle of the nozzle plate. The transport device transports at least one of the substrate and the droplet ejection head relative to the other along one direction. The semiconductor laser radiates a laser beam for drying the droplets on the substrate. The reflective mirror is provided in the droplet ejection head and guides the laser beam of the semiconductor laser onto an area on the substrate opposed to the nozzle plate in such a manner that the radiating direction of the laser beam with respect to the droplets becomes substantially parallel with the one direction, as viewed in a normal direction of the substrate. The first shifting device moves at least one of the reflective mirror and the substrate in such a manner that the distance between a reflective surface of the reflective mirror and the substrate becomes shorter than the distance between the nozzle plate and the substrate.

### CROSS-REFERENCE TO RELATED APPLICATIONS

This application is based upon and claims the benefit of priority from prior Japanese Patent Application No. 2006-119562 filed on Apr. 24, 2006, the entire contents of which are incorporated herein by reference.

### BACKGROUND

The present invention relates to a droplet ejection apparatus and an identification code.

Typically, a display such as a liquid crystal display or an electroluminescence display includes a transparent substrate by which an image is displayed. An identification code (for example, a two-dimensional code), which represents product information including the site of production and the product number, is formed on this type of substrate for the purposes of quality control and production management. The identification code includes, for example, a plurality of dots that are formed by thin color films or defined by recesses. The dots are arranged in such a manner as to form a prescribed mark, and the arrangement pattern of the dots determines the identification code.

As a method for forming such an identification code, Japanese Laid-Open Patent Publication No. 11-77340 proposes a laser sputtering method in which laser beams are radiated onto a metal foil to form dots. Further, Japanese Laid-Open Patent Publication No. 2003-127537 proposes a waterjet method in which dots are marked on a substrate by ejecting water containing abrasive onto the substrate.

To obtain dots of a desirable size by the laser sputtering method, the space between the metal foil and the substrate must be adjusted to several or several tens of micrometers. That is, while the surfaces of the substrate and the metal foil must be highly flat, the space between the metal foil and the substrate must be adjusted in the range of error at the order of micrometers. The laser sputtering method is thus applicable only to limited types of substrates and cannot be broadly employed. Further, in the waterjet method, the substrate may be contaminated through splashing of water or dust or abrasive caused by formation of the identification code on the substrate.

To solve these problems in formation of identification codes, an inkjet method has been focused on as an alternative method for forming an identification code. In the inkjet method, droplets of liquid containing metal particles are ejected from a droplet ejection head onto a substrate. The droplets are dried to form dots on the substrate. The inkjet method is thus applicable to a relatively large number of types of substrates. The method also allows formation of an identification code without contaminating the substrate.

Nonetheless, the sizes of the droplets that have been received by the substrate change over time in correspondence with the surface condition of the substrate or the surface tension acting in the droplets. The droplets, the sizes of which change in this manner, determine the sizes of the resulting dots in correspondence with the timings at which the droplets are dried. For example, if droplets of metal ink each having an outer diameter of 30 μm are ejected onto a lyophilic substrate, the outer diameter of each of the droplets reaches 70 μm after 100 milliseconds and 100 μm after 200 milliseconds. Therefore, if the timing at which the droplets are dried varies in the range of 100 to 200 milliseconds after the droplets are received by the substrate, the outer diameters of the dots vary in the range of approximately 70 μm to 100 μm.

To suppress such variation of the dot sizes, laser drying has been proposed as a method for drying droplets. The laser drying is performed by radiating a laser beam onto droplets on the substrate. Specifically, in the laser drying, the droplets are dried only in a laser radiation area. This improves accuracy of controlling the timings at which the droplets on the substrate are dried, suppressing the dot size variation.

Since the droplets onto which the laser beam is radiated in the laser drying are extremely small, bumping or splashing of droplets may be caused if the energy density of the laser beam increases. To solve this problem, a low-energy-density radiation area (a beam spot) in which the droplets are prevented from spreading wet is defined on the substrate in the laser drying. The droplets are thus allowed to remain in the beam spot only for a predetermined drying time.

In the inkjet method, a substrate is moved (scanned) relative to a droplet ejection head to enhance productivity for forming a mark. Therefore, the time in which the droplets remain in the beam spot, or the radiation time in which the laser beam is radiated onto the droplets, is limited by the movement speed (the scanning speed) of the substrate. As a result, if the movement speed of the substrate is excessively great or the drying speed of the droplet is excessively slow, the drying time of the droplets becomes insufficient, disadvantageously leading to defective drying of droplets and defective mark formation.

### SUMMARY

Accordingly, it is an objective of the present invention to increase droplet drying time without decreasing productivity for forming a mark and suppress formation defects of the mark.

To achieve the foregoing objective and in accordance with one aspect of the present invention, a droplet ejection apparatus that ejects liquid droplets containing a mark forming material onto a substrate is provided. The apparatus includes a droplet ejection head, a transport device, a laser source, a n optical member, and a first shifting device. The droplet ejection head has a nozzle plate opposed to the substrate. The droplets are ejected from nozzles of the nozzle plate. The transport device transports at least one of the substrate and the droplet ejection head relative to the other along one direction. The laser source radiates a laser beam for drying the droplets on the substrate. The optical member is provided in the droplet ejection head. The optical member guides the laser beam of the laser source onto an area on the substrate opposed to the nozzle plate in such a manner that the radiating direction of the laser beam with respect to the droplets becomes substantially parallel with the one direction as viewed in a normal direction of the substrate. The first shifting device shifts at least one of the optical member and the substrate in such a manner that the distance between an optical surface of the optical member and the substrate becomes shorter than the distance between the nozzle plate and the substrate.

In accordance with a second aspect of the present invention, an identification code is provided that is formed by a plurality of dots provided on a surface of a substrate using the droplet ejection apparatus according to the first aspect of the present invention.

In accordance with a third aspect of the present invention, a method for forming a mark on a substrate by ejecting liquid droplets containing a mark forming material onto the substrate is provided. The method includes: ejecting the droplets onto the substrate through nozzles defined in a nozzle plate of a droplet ejection head while moving at least one of the substrate and the droplet ejection head relative to the other along one direction; drying the droplets by radiating a laser beam onto the droplets on the substrate; guiding the laser beam onto an area on the substrate opposed to the nozzle plate by means of an optical member in such a manner that the radiating direction of the laser beam with respect to the droplets becomes substantially parallel with the one direction as viewed in a normal direction of the substrate; and shifting at least one of the optical member and the substrate in such a manner that the distance between an optical surface of the optical member and the substrate becomes shorter than the distance between the nozzle plate and the substrate.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing a liquid crystal display according to a first embodiment of the present invention;

FIG. 2 is a front view showing an identification code formed on the liquid crystal display of FIG. 1;

FIG. 3 is a perspective view showing a droplet ejection apparatus by which the identification code of FIG. 2 is formed;

FIG. 4 is a side view showing a main portion of the droplet ejection apparatus of FIG. 3;

FIG. 5 is a perspective view showing a droplet ejection head of the droplet ejection apparatus of FIG. 3;

FIG. 6 is a cross-sectional view showing a main portion of the droplet ejection head of FIG. 5;

FIG. 7 is a side view schematically showing a reflective mirror of the droplet ejection apparatus of FIG. 3;

FIG. 8 is a side view schematically showing the reflective mirror like FIG. 7;

FIG. 9 is a view for explaining the relationship between the reflective mirror and the droplet ejection head;

FIG. 10 is a block diagram representing the electric configuration of the droplet ejection apparatus according to the first embodiment of the present invention;

FIG. 11 is a view for explaining the relationship between a reflective mirror and a droplet ejection head according to a second embodiment of the present invention;

FIG. 12 is a view for explaining the relationship between the reflective mirror and the droplet ejection head like FIG. 11; and

FIG. 13 is a block diagram representing the electric configuration of the droplet ejection apparatus according to the second embodiment of the present invention.

### DESCRIPTION OF EXEMPLARY EMBODIMENTS

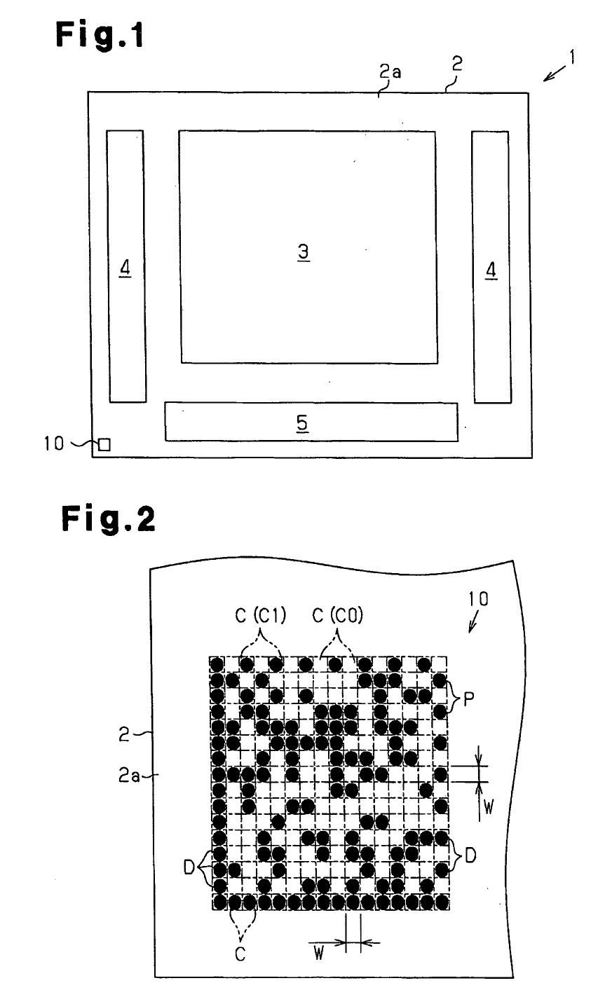

A first embodiment of the present invention will now be described with reference to FIGS. 1 to 10. First, a liquid crystal display 1 having an identification code 10 according to the present invention will be explained referring to FIGS. 1 and 2.

Referring to FIG. 1, the liquid crystal display 1 has a colorless transparent glass substrate 2. The glass substrate is provided with a rectangular display portion 3 which is located substantially in a central portion of one surface (a surface 2a) of the glass substrate. Liquid crystal molecules are sealed in the display portion 3. Scanning line driver circuits 4 and a data line driver circuit 5 are provided outside the display portion 3. The scanning line driver circuits 4 generate scanning signals and the data line driver circuit 5 generates data signals. In correspondence with these signals, the liquid crystal display 1 modulates the orientation of the liquid crystal molecules in the display portion 3 to display a desired image on an area on the display portion 3. The identification code 10, or a mark, is formed in the vicinity of the lower corner at the left side of the display portion 3. The identification code 10 is shaped as a square each side of which is approximately 1 mm.

Referring to FIG. 2, the identification code 10 is virtually divided into a plurality of cells C, which form a matrix of 16 rows and 16 columns. In the areas of selected ones of the cells C, dots D respectively are formed. The identification code 10 reproduces the product number or the lot number of the liquid crystal display 1 by the presence and absence of dots D in respective cells C.

The outer diameter of each of the dots D is equal to the length of each side of each cell C. Each dot D has a semispherical shape. The dots D are provided by ejecting droplets Fb onto the cells C and drying the droplets Fb in the cells C. The droplets Fb are of a metal ink F, or mark forming material, in which metal particles (for example, nickel particles or manganese particles) are dispersed. The droplets Eb in the cells C are dried through radiation of a laser beam L2.

In the first embodiment, the center of each cell C in which the dot D is formed, referring to FIG. 2, is defined as an ejection target position P. The length of each side of the cell C is defined as cell width W. Further, with reference to FIG. 2, the cells C in which the dots D are provided are defined as black cells C1 and the cells C that are empty, or in which the dots D are not provided, are defined as blank cells C0.

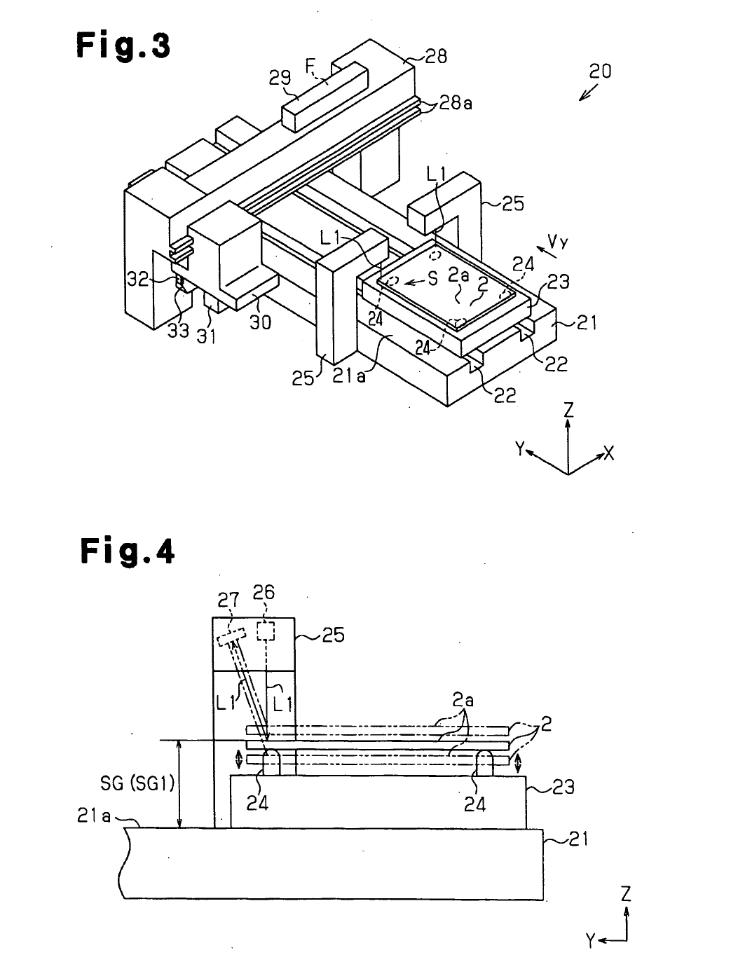

Next, a droplet ejection apparatus 20 using which the identification code 10 is formed will be described with reference to FIGS. 3 to 10. FIG. 3 is a perspective view schematically showing the droplet ejection apparatus 20. FIG. 4 is a side view showing a main portion of the droplet ejection apparatus 20.

As shown in FIG. 3, a base 21 shaped like a rectangular parallelepiped is provided in the droplet ejection apparatus 20. A pair of guide grooves 22, which extend in the longitudinal direction of the base 21 (direction Y or movement direction of the base 21), are defined in the top surface of the base 21. A stage 23 on which the glass substrate 2 is mounted is provided above the guide grooves 22 and functions as a transport device (a scanning device). The stage 23 is guided by the guide grooves 22 to move in direction Y and the direction opposite to direction Y at a predetermined speed (a transport speed Vy).

In the first embodiment, a direction extending along the top surface of the base 21 and perpendicular to direction Y is defined as direction X. A normal direction of the top surface of the base 21 is defined as direction Z. Further, the top surface of the base 21 extending parallel with both directions X and Y is defined as a reference surface 21a.

As shown in FIGS. 3 and 4, lift mechanisms 24, each of which forms a second shifting device, are arranged on the top surface of the stage 23 and at the positions corresponding to the four corners of the glass substrate 2. Each of the lift mechanisms 24 has a piezoelectric actuator, which extends and contracts in an up-and-down direction in response to a prescribed drive signal.

The lift mechanisms 24 correct the position of the glass substrate 2 that is held on the stage 23, in such a manner that the surface 2a of the glass substrate 2 extends parallel with the reference surface 21a and the distance between the surface 2a and the reference surface 21a becomes a predetermined value. After the position of the glass substrate 2 is corrected, the substrate 2 can be moved in direction Y and the direction opposite to the direction Y together with the stage 23 through the lift mechanisms 24.

In the first embodiment, the distance between the surface 2a and the reference surface 21a is defined as a substrate height SG. Further, the substrate height SG at which the identification code 10 is formed on the substrate 2 is defined as a marking height SG1.

The base 21 has a pair of height sensors 25, which form a distance information generation device. Each of the height sensors 25 is located outside the base 21 in direction X. Each height sensor 25 has a radiating portion 26 and a light receiving portion 27. Each of the radiating portions 26 radiates a laser beam L1 onto an outer end of the surface 2a, which opposes the radiating portions 26, when the glass substrate 2 is moved (scanned). The laser beams L1 are then reflected by the outer end of the surface 2a and detected by the corresponding light receiving portions 27. Each of the height sensors 25 detects the substrate height SG of an area on the glass substrate 2 onto which the laser beam has been radiated in accordance with the detection result of the corresponding one of the light receiving portions 27.

With reference to FIG. 3, a guide member 28 is arranged at a position forward from the two height sensors 25 in direction Y in the droplet ejection apparatus 20. The guide member 28 is shaped like a gate straddling the base 21. An ink tank 29, which retains the metal ink F, is formed on the top surface of the guide member 28. The ink tank 29 retains the metal ink F and supplies the metal ink F to a droplet ejection head (hereinafter, referred to simply as an ejection head) 31, which is provided below the ink tank 29, under a predetermined level of pressure.

The guide member 28 has a pair of guide rails 28a. Each of the guide rails 28a projects from the surface of the guide member 28 and extends in direction X. A carriage 30, which is movable in direction X and the direction opposite to direction X along the guide rails 28a, is secured to the guide rails 28a. The ejection head 31, a mirror stage 32, or a first shifting device, and a reflective mirror 33, or an optical member, are provided at the bottom surface of the carriage 30.

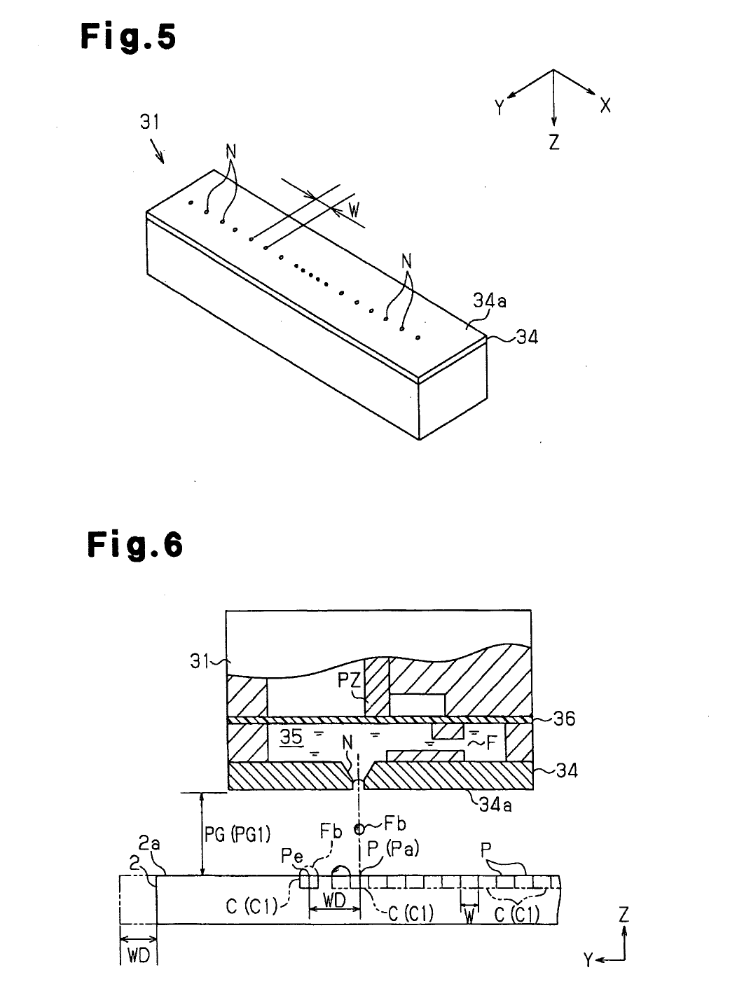

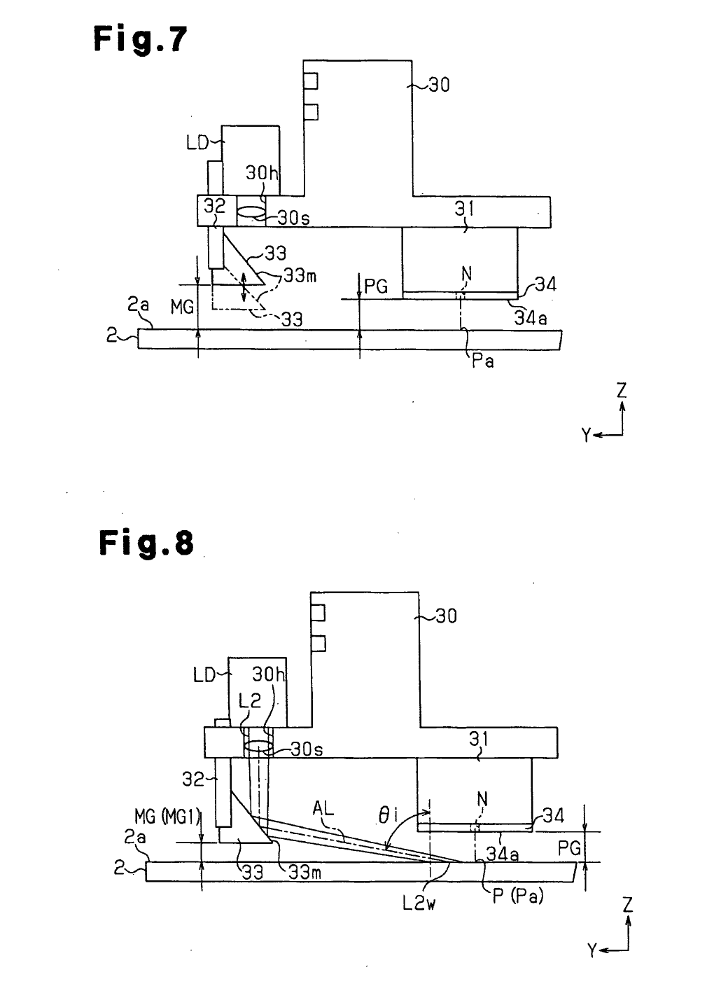

FIG. 5 is a perspective view showing the ejection head 31 as viewed from the side corresponding to the glass substrate 2. FIG. 6 is a schematic cross-sectional view for explaining the interior of the ejection head 31. FIGS. 7 to 9 are views for explaining the mirror stage 32 and the reflective mirror 33.

With reference to FIGS. 5 and 6, a nozzle plate 34 is formed in a lower portion (an upper portion as viewed in FIG. 5) of the ejection head 31. A nozzle forming surface 34a parallel with the reference surface 21a is formed in the bottom surface (the top surface as viewed in FIG. 5) of the nozzle plate 34.

In the first embodiment, the distance between the nozzle forming surface 34a and the surface 2a is defined as a platen gap PG. The platen gap GP that allows formation of the identification code 10 is defined as a reference value (an ejection gap PG1).

A plurality of nozzles N, each of which extends in direction Z, extend through the nozzle forming surface 34a and are aligned along direction X and spaced at equal intervals. A formation pitch of the nozzles N, or an interval between each adjacent pair of the nozzles N, is equal to the cell width W. When the glass substrate 2 moves, the nozzles N sequentially oppose a corresponding column of the cells C (the ejection target positions P) aligned along the movement direction of the glass substrate 2. In the first embodiment, a position defined on the surface 2a and opposed to a corresponding one of the nozzles N is defined as a droplet receiving position Pa.

The ejection head 31 has cavities 35 corresponding to the nozzles N. Each of the cavities 35 communicates with the ink tank 29 and supplies the metal ink F from the ink tank 29 to the nozzles N. An oscillation plate 36, which is capable of oscillating in the up-and-down direction, is provided above each cavity 35. Piezoelectric elements PZ are formed on the top surfaces of the oscillation plates 36 in correspondence with the nozzles N. In response to a prescribed drive signal, each of the piezoelectric elements PZ extends and contracts in the up-and-down direction.

When the ejection target positions P on the surface 2a reach the corresponding droplet receiving positions Pa as the glass substrate 2 moves, the piezoelectric elements PZ extend and contract in response to prescribed drive signals and oscillate the oscillation plates 36, thus increasing and decreasing the volumes of the corresponding cavities 35. This oscillates the gas-liquid interfaces of the metal ink F in the corresponding nozzles N, causing ejection of droplets Fb. The ejected droplets Fb travel in the direction opposite to direction Z and reach the corresponding droplet receiving positions Pa (ejection target positions P). The droplets Fb then spread wet on the surface 2a and, after a predetermined time, the outer diameter of each droplet Fb becomes equal to the cell width W.

In the first embodiment, a position of each droplet Fb when the outer diameter of the droplet Fb becomes equal to the cell width W is defined as a drying start position Pe. The distance between each droplet receiving position Pa and the corresponding drying start position Pe is defined as a radiation standby distance WD.

Referring to FIGS. 7 and 8, a through hole 30h, which extends substantially along the entire width of the carriage 30 in direction X, is defined in the vicinity of an end of the carriage 30 in direction Y. The through hole 30h extends through the carriage 30 in the up-and-down direction. A semiconductor laser LD serving as a laser source is provided in the carriage 30 at a position corresponding to the upper opening of the through hole 30h. A cylindrical lens 30s is arranged in the through hole 30h.

In response to a prescribed drive signal, the semiconductor laser LD downwardly radiates a collimated laser beam L2, which extends in direction X in a belt-like shape. The laser beam L2 is a laser beam with a wavelength (which is, in the first embodiment, 808 nm) corresponding to the absorption wavelength of the metal ink F and evaporates dispersion medium from the droplets Fb. The cylindrical lens 30s is a lens that has curvature solely in direction Y. The cylindrical lens 30s receives the laser beam L2 from the semiconductor laser LD and converges only the elements in direction Y (or the direction opposite to direction Y) of the laser beam L2.

The mirror stage 32 extending downward is provided below the carriage 30. The mirror stage 32 suspends the reflective mirror 33 in such a manner that the reflective mirror 33 is located immediately below the through hole 30h.

The mirror stage 32 is a liner movement mechanism that moves the reflective mirror 33 in the up-and-down direction. In response to a prescribed drive signal, the mirror stage 32 lowers (or raises) the reflective mirror 33 to a predetermined position. Specifically, the mirror stage 32 moves the reflective mirror 33 between a position (an initial position indicated by the solid lines in FIG. 7) at which the lower end of the reflective mirror 33 is located upward from the nozzle forming surface 34a and at a position (a radiating position indicated by the chain lines in FIG. 7) at which the lower end of the reflective mirror 33 is located downward from the nozzle forming surface 34a.

The reflective mirror 33 is a right angle prism mirror having an inclined reflective surface 33m, or an optical surface. The reflective mirror 33 (the reflective surface 33m) is formed in such a manner that the width of the reflective mirror 33 in direction X becomes substantially equal to the width of the cylindrical lens 30s in direction X. The reflective mirror 33 receives the laser beam L2 that has passed through the cylindrical lens 30s at the reflective surface 33m. The reflective mirror 33 then reflects the laser beam L2 toward a position below the ejection head 31. The reflective surface 33m reflects the laser beam L2 in such a manner that the optical axis AL of the reflected laser beam L2 extends along direction Y, as viewed in direction Z (from above). Specifically, the reflective surface 33m reflects the laser beam L2 that has passed through the cylindrical lens 30s substantially in a tangential direction of the surface 2a (substantially in a parallel direction with the movement direction of the glass substrate 2). Further, the reflective surface 33m guides the beam waist L2w of the reflected laser beam L2 onto the surface 2a, in such a manner that the angle (an incident angle θi) between the radiating direction of the laser beam L2 and a normal line of the surface 2a (an X-Y plane) becomes 88.5°.

In the first embodiment, the distance between the lower end of the reflective surface 33m and the surface 2a is defined as a mirror gap MG. The mirror gap MG that allows formation of the identification code 10 is defined as a radiation gap MG1.

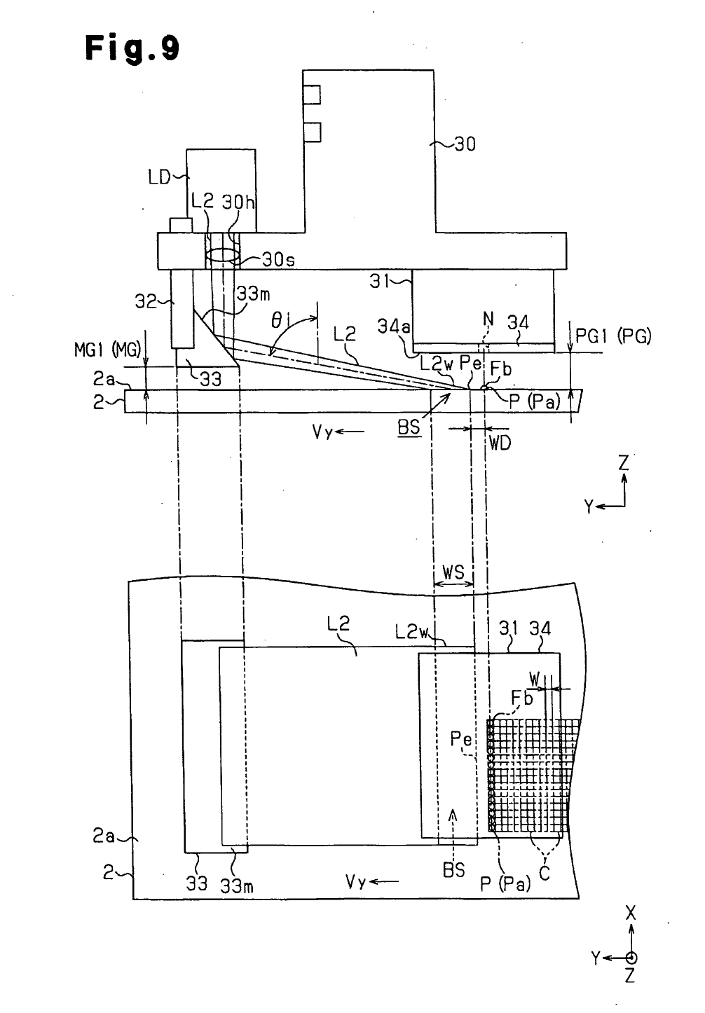

As illustrated in FIG. 9, the mirror stage 32 shifts the reflective mirror 33 to a radiating position when the ejection head 31 ejects droplets Fb. With the reflective mirror 33 arranged at the radiating position, the mirror gap MG is changed to the radiation gap MG1, which is smaller than the platen gap PG (the ejection gap PG1).

In other words, when the reflective mirror 33 is located at the radiating position, the lower end of the reflective surface 33m is arranged downward from the nozzle forming surface 34a (closer to the surface 2a). In this manner, the reflective mirror 33 reflects the laser beam L2 in such a manner that the laser beam L2 extends substantially along a normal direction of the surface 2a (at the incident angle θi). The laser beam L2 is thus introduced into the gap between the nozzle plate 34 and the glass substrate 2. The laser beam L2 then forms an optical cross section (a beam spot BS) corresponding to the beam waist L2w of the laser beam L2 on the surface 2a. In the first embodiment, the radiating direction of the laser beam L2 extends substantially along the tangential direction of the surface 2a. This increases the spot width WS of the beam spot BS on the surface 2a in direction Y.

In the first embodiment, the ejection gap PG1 is set to 300 μm and the radiation gap MG is set to 100 μm. The radiation gap MG1 is set in such a manner that the end of the beam spot BS in the direction opposite to direction Y is located at the drying start positions Pe.

After having reached the droplet receiving positions Pa, the droplets Fb move in direction Y as the glass substrate 2 moves. After having covered the radiation standby distance WD, the outer diameters of the droplets Fb become equal to the cell width W. The droplets Fb then pass the drying start positions Pe. While passing the drying start positions Pe, the droplets Fb enter the beam spot BS in which drying of the droplets Fb is started.

At this stage, the energy density of the laser beam L2 radiated onto the droplets Fb decreases and the radiation time (the spot width WS/the transport speed Vy) increases as the spot width WS increases. As a result, bumping and splashing of the received droplets Fb are avoided and the dispersion medium or solvent is reliably evaporated from the received droplets Fb. In other words, the received droplets Fb are fixed to the corresponding cells C without flowing out from the corresponding cells C, thus forming the dots D each having an outer diameter equal to the cell width W.

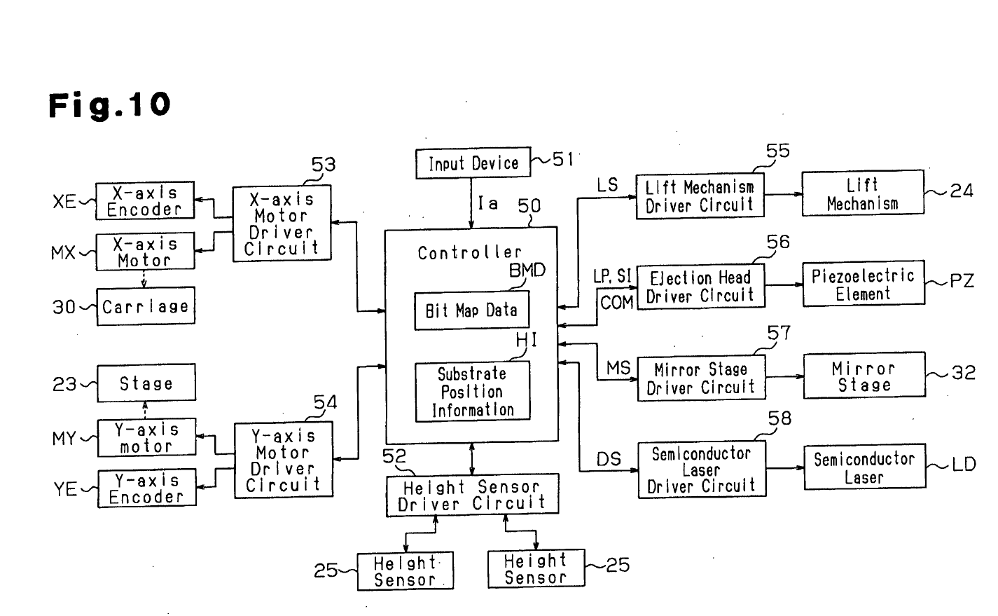

Next, the electric configuration of the droplet ejection apparatus 20, which is configured as above-described, will be explained with reference to FIG. 10.

A controller 50, which is illustrated in FIG. 10, has a CPU, a ROM, and a RAM (none of which is shown). In accordance with various types of stored data and various types of stored control programs, the controller 50 operates to move the stage 23, the lift mechanisms 24, the carriage 30, and the mirror stage 32, and controls operation of the semiconductor laser LD and the piezoelectric elements PZ. For example, the controller 50 stores information regarding the substrate height SG as substrate position information HI, or distance information. In accordance with the substrate position information HI, the controller 50 controls operation of the lift mechanisms 24 and corrects the substrate height SG of the glass substrate 2 to the marking height SG1.

An input device 51 having manipulation switches such as a start switch and a stop switch is connected to the controller 50. The input device 51 inputs information regarding the position coordinates of the black cells C1 with respect to a marking plane (the surface 2a) as a prescribed form of marking information Ia. The controller 50 generates bit map data BMD in accordance with the marking information Ia provided by the input device 51.

The bit map data BMD instructs whether to turn on or off the piezoelectric elements PZ in accordance with the bit values (0 or 1) corresponding to the cells C. That is, in accordance with the bit map data BMD, the piezoelectric elements PZ are operated in such a manner that the droplets Fb are ejected onto the black cells C1 (the ejection target positions P) but are prevented from being ejected onto the blank cells C0.

The controller 50 outputs a drive control signal to a height sensor driver circuit 52. In response to the drive control signal, the height sensor driver circuit 52 operates to radiate the laser beams L1 through the radiating portions 26 of the height sensors 25. The reflected light of each of the laser beam L1 is received by the corresponding one of the light receiving portions 27. In correspondence with the intensity of the reflected light received by each light receiving portion 27, the height sensor driver circuit 52 provides a detection signal corresponding to the substrate height SG to the controller 50. In accordance with the detection signal, the controller 50 generates and stores the substrate position information HI. Based on the stored substrate position information HI, the controller 50 produces a drive signal (a lift mechanism drive signal LS) in response to which the substrate height SG is switched to the marking height SG1. The controller 50 then provides the drive signal to a lift mechanism driver circuit 55.

The controller 50 provides a drive control signal to an X-axis motor driver circuit 53. In response to the drive control signal, the X-axis motor driver circuit 53 operates to rotate an X-axis motor MX, which drives and moves the carriage 30, in a forward direction or a reverse direction. An X-axis encoder XE is connected to the X-axis motor driver circuit 53 and inputs a detection signal to the X-axis motor driver circuit 53. In correspondence with the detection signal, the X-axis motor driver circuit 53 produces a signal regarding the movement direction and the movement amount of the carriage 30 (the droplet receiving positions Pa) and outputs the signal to the controller 50.

The controller 50 provides a drive control signal to a Y-axis motor driver circuit 54. In response to the drive control signal, the Y-axis motor driver circuit 54 operates to rotate a Y-axis motor MY, which drives and moves the stage 23, in a forward direction or a reverse direction. A Y-axis encoder YE is connected to the Y-axis motor driver circuit 54 and inputs a detection signal to the Y-axis motor driver circuit 54. In correspondence with the detection signal, the Y-axis motor driver circuit 54 produces a signal regarding the movement direction and the movement amount of the stage 23 (the surface 2a) and outputs the signal to the controller 50. Based on the signal from the Y-axis motor driver circuit 54, the controller 50 outputs an ejection timing signal LP to an ejection head driver circuit 56 each time the black cells C1 (the ejection target positions P) reach the droplet receiving positions Pa.

The controller 50 outputs a lift mechanism drive signal LS to the lift mechanism driver circuit 55 to control operation of the lift mechanisms 24. In response to the lift mechanism drive signal LS, the lift mechanism driver circuit 55 operates the lift mechanisms 24 in such a manner as to set the substrate height SG of the glass substrate 2 to the marking height SG1.

The controller 50 supplies piezoelectric element drive voltage COM to the ejection head driver circuit 56 to operate the piezoelectric elements PZ synchronously with the ejection timing signal LP. Further, the controller 50 generates ejection control signals SI synchronized with a predetermined clock signal in accordance with the bit map data BMD. The controller 50 then serially transfers the ejection control signals SI to the ejection head driver circuit 56. The ejection head driver circuit 56 sequentially converts the ejection control signals SI provided by the controller 50, which are in serial forms, into parallel forms in correspondence with the piezoelectric elements PZ. Each time the ejection head driver circuit 56 receives the ejection timing signal LP from the controller 50, the ejection head driver circuit 56 latches the ejection control signals SI, which have been converted from the serial forms into the parallel forms, and supplies the piezoelectric element drive voltage COM commonly to the selected ones of the piezoelectric elements PZ.

The controller 50 provides a mirror stage drive signal MS to a mirror stage driver circuit 57 to control operation of the mirror stage 32. In response to the mirror stage drive signal MS from the controller 50, the mirror stage driver circuit 57 operates the mirror stage 32 to set the mirror gap MG of the reflective mirror 33 to the radiation gap MG1.

The controller 50 provides a laser drive signal DS to a semiconductor laser driver circuit 58 to control operation of the semiconductor laser LD. In response to the laser drive signal DS from the controller 50, the semiconductor laser driver circuit 58 operates the semiconductor laser LD to radiate the laser beam L2.

A method for forming the identification code 10 using the droplet ejection apparatus 20 will be explained in the following.

First, as illustrated in FIG. 3, the glass substrate 2 is mounted on the lift mechanisms 24 in such a manner that the surface 2a faces upward. In this state, the stage 23 arranges the glass substrate 2 at a position rearward from the two height sensors 25 in direction Y. The mirror stage 32 arranges the reflective mirror 33 at the initial position.

In this state, the marking information Ia is input to the controller 50 through the input device 51. The controller 50 generates and stores the bit map data BMD based on the marking information Ia. Then, the controller 50 operates the X-axis motor driver circuit 53 to move the carriage 30 (the ejection head 31) to the predetermined position in such a manner that, when the glass substrate 2 is moved, the ejection target positions P pass the corresponding droplet receiving positions Pa. Afterwards, the controller 50 starts moving the glass substrate 2 through the Y-axis motor driver circuit 54.

Then, the controller 50 detects the substrate height SG of the glass substrate 2 through the height sensor driver circuit 52 and sets the substrate height SG to the marking height SG1 through the lift mechanism driver circuit 55. Further, the controller 50 operates the mirror stage 32 through the mirror stage driver circuit 57 to move the reflective mirror 33 to the radiating position. In this manner, the platen gap PG becomes equal to the ejection gap PG1 and the mirror gap MG becomes equal to the radiation gap MG1.

Subsequently, the controller 50 operates the semiconductor laser LD through the semiconductor laser driver circuit 58 to radiate the laser beam L2 onto the reflective mirror 33. Therefore, when the glass substrate 2 moves immediately below the ejection head 31, the laser beam L2 projected substantially in the tangential direction of the surface 2a is radiated onto the area on the surface 2a opposed to the ejection head 31. In other words, as the glass substrate 2 moves immediately below the ejection head 31, the beam spot BS having the spot width WS increased in the movement direction is formed in the area on the surface 2a opposed to the ejection head 31.

Next, the controller 50 outputs the ejection control signals SI based on the bit map data BMD to the ejection head driver circuit 56. The controller 50 outputs the ejection timing signal LP each time the black cells C1 reach the droplet receiving positions Pa. That is, each time the ejection target positions P reach the droplet receiving positions Pa, the controller 50 operates the ejection head driver circuit 56 to eject droplets Fb through those of the nozzles N that are selected in accordance with the ejection control signals SI.

The ejected droplets Fb are received at the corresponding ejection target positions P and spread wet. When the droplets Fb reach the drying start positions Pe, the outer diameter of each of the droplets Fb becomes equal to the cell width W. The droplets Fb, each having the outer diameter equal to the cell width W, then enter the beam spot BS and drying of the droplets Fb is started. As the spot width WS increases, the energy density of the laser beam L2 radiated onto the droplets Fb, drying of which has started, decreases and the radiation time (the spot width WS/the transport speed Vy) of the laser beam L2 is prolonged. As a result, bumping and splashing of the received droplets Fb are avoided and the dispersion medium and the solvent are reliably evaporated from the droplets Fb. The droplets Fb are thus fixed to the corresponding cells C and form the dots D each having the outer diameter equal to the cell width W.

The first embodiment, which is configured as above-described, has the following advantages.

(1) In the first embodiment, the reflective mirror 33 reflects the laser beam L2 radiated by the semiconductor laser LD substantially along the tangential direction of the surface 2a. The mirror stage 32 shifts the reflective mirror 33 in the up-and-down direction and changes the distance (the mirror gap MG) between the reflective surface 33m and the surface 2a. For ejection of the droplets Fb, the mirror stage 32 moves the reflective mirror 33 downward in such a manner that the mirror gap MG becomes shorter than the distance (the platen gap GP) between the ejection head 31 and the surface 2a.

The laser beam L2 thus forms the beam spot BS in the area on the surface 2a opposed to the ejection head 31 and increases the spot width WS of the beam spot BS in the tangential direction of the surface 2a (the movement direction of the glass substrate 2). As a result, the energy density of the laser beam L2 radiated onto the droplets Fb lowers and the radiation time of the laser beam L2 (the spot width WS/the transport speed Vy) is prolonged. This prolongs the drying time of the droplets Fb without lowering productivity for forming the dots D and suppresses formation defects of the dots D while avoiding bumping and splashing of the received droplets Fb.

(2) In the first embodiment, the two height sensors 25 detect the substrate height SG and the lift mechanisms 24 correct the position of the glass substrate 2 in correspondence with the substrate height SG detected by the height sensors 25. For ejection of the droplets Fb, the lift mechanisms 24 set the substrate height SG to the marking height SG1 and the platen gap PG to the ejection gap PG1.

Therefore, regardless of the mounting state of the glass substrate 2, the mirror gap MG when the droplets Fb are ejected is further reliably shortened to a value smaller than the platen gap PG. This further reliably prolongs the drying time of the droplets Fb.

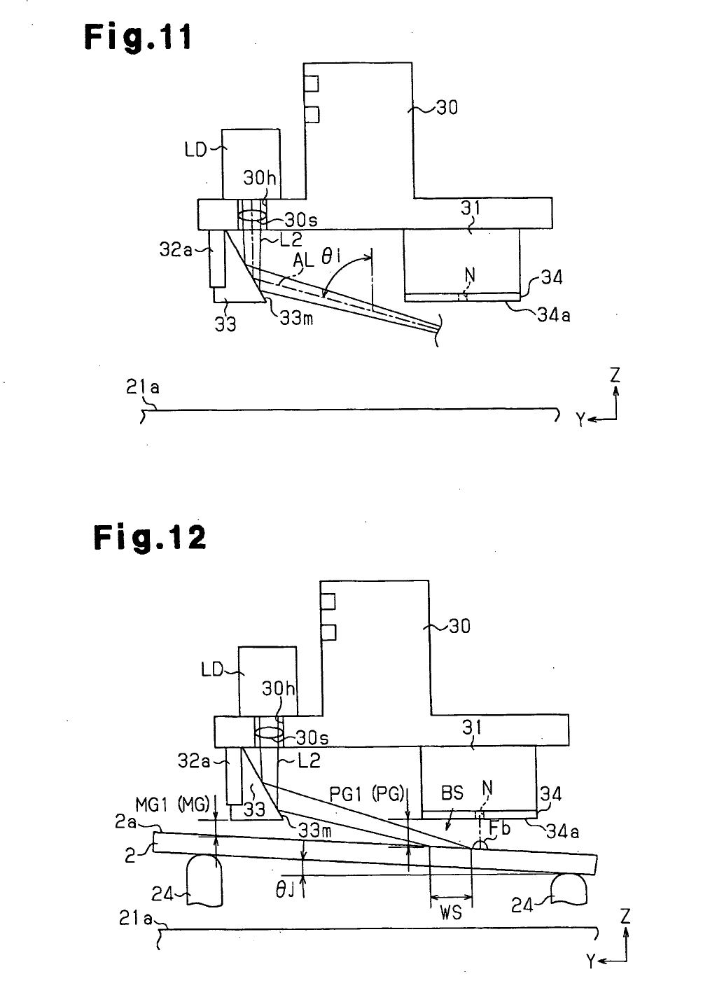

Next, a second embodiment of the present invention will be described with reference to FIGS. 11 to 13. In the second embodiment, the first shifting device is embodied by each of the lift mechanisms 24. The structures of the other portions of the second embodiment are identical to the structures of the corresponding portions of the first embodiment.

As shown in FIG. 11, a support member 32a projects downward from a position in the vicinity of the end of the carriage 30 in direction Y. The support member 32a fixedly supports the reflective mirror 33 to the carriage 30. By means of the support member 32a, the height of the lower end of the reflective surface 33m with respect to the reference surface 21a (the X-Y plane) and the height of the nozzle forming surface 34a with respect to the reference surface 21a become equal to each other. The reflective mirror 33 receives the laser beam L2 from the cylindrical lens 30s at the reflective surface 33m and sends the laser beam L2 to a position below the nozzle plate 34. The reflective surface 33m sets the incident angle θei of the laser beam L2 with respect to a normal line of a plane parallel with the direction X and the direction Y to 86.5°.

As illustrated in FIG. 12, for ejection of the droplets Fb, the lift mechanisms 24, each of which serves as the first shifting device, lift the glass substrate 2 at a position in the vicinity of the end of the glass substrate 2 in direction Y. In this state, the glass substrate 2 is moved in direction Y by the stage 23. More specifically, for ejection of the droplets Fb onto the glass substrate 2, the lift mechanisms 24 shift the glass substrate 2 in such a manner that the angle (the inclination angle θj) between the tangential direction of the glass substrate 2 and the tangential direction of the reference surface 21a is maintained at a predetermined angle (in the second embodiment, 2°). Further, in this state, the lift mechanisms 24 maintain the platen gap PG at the ejection gap PG1 and the mirror gap MG at a distance (the radiation gap MG1) shorter than the ejection gap PG1.

As a result, in correspondence with the inclination angle θj, the angle (the incident angle) between the radiating direction of the laser beam L2 proceeding between the nozzle plate 34 and the glass substrate 2 and the normal line of the reference surface 2a becomes closer to 90°. In other words, the radiating direction of the laser beam L2 approximates the tangential direction of the surface 2a in correspondence with the inclination angle θj and thus the width (the spot width WS) of the beam spot BS in the tangential direction increases. As a reuslt, the energy density of the laser beam L2 radiated onto the droplets Fb decreases and the radiation time of the laser beam L2 is prolonged.

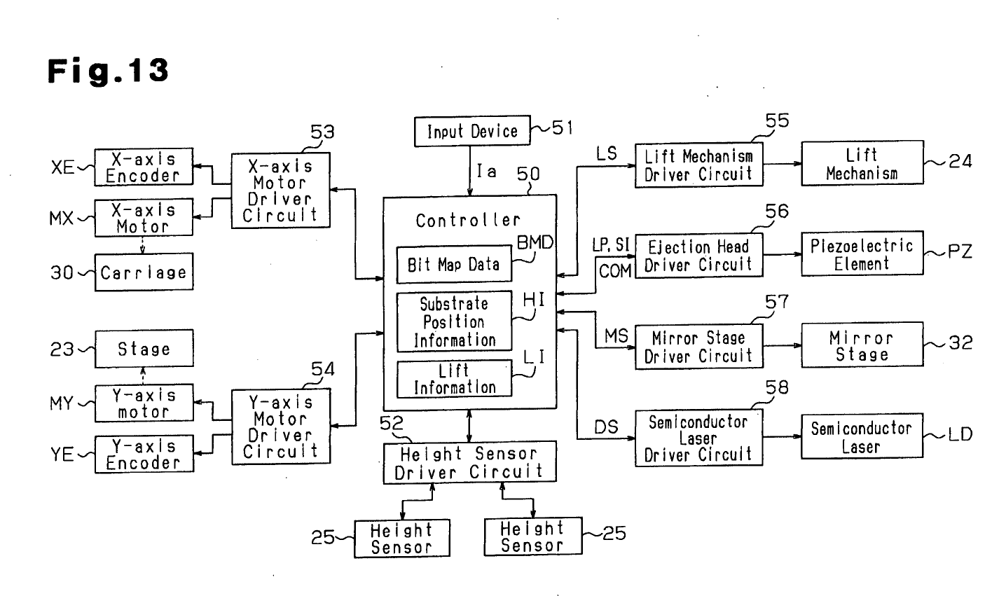

The electric configuration of the droplet ejection apparatus 20, which is configured as above-described, will be explained with reference to FIG. 13.

As illustrated in FIG. 13, lift information LI, or shifting information, is stored in the controller 50, which serves as a shifting information generating section and a control section. The lift information LI is information regarding the drive amount of the lift mechanisms 24 over time. The lift information LI is generated by the controller 50 based on the substrate position information HI. Specifically, in accordance with the lift information LI, the inclination angle θj of the glass substrate 2 is maintained and the mirror gap MG and the platen gap PG are maintained at the radiation gap MG1 and the ejection gap PG1, respectively, in ejection of the droplets Fb. For ejection of the droplets Fb, the controller 50 produces a lift mechanism drive signal LS in accordance with the lift information LI and operates the lift mechanisms 24 through the lift mechanism driver circuit 55.

Specifically, the marking information Ia is input to the controller 50 through the input device 51. The controller 50 stores the bit map data BMD based on the marking information Ia and moves the carriage 30 to the predetermined position to start the transport of the glass substrate 2. After the transport of the glass substrate 2 is started, the controller 50 detects the substrate height SG of the glass substrate 2 and generates and stores the substrate position information HI. The controller 50 then generates and stores the lift information LI in accordance with the substrate position information HI. Subsequently, in ejection of the droplets Fb, the controller 50 provides the lift mechanism drive signal LS based on the lift information LI to the lift mechanism driver circuit 55 and thus controls operation of the lift mechanisms 24. In this manner, when the droplets Fb are dried, the mirror gap MG and the platen gap PG are maintained at the radiation gap MG1 and the ejection gap PG1, respectively. As a result, the beam spot BS having the spot width WS increased in the tangential direction is formed on the glass substrate 2.

The second embodiment, which is configured as above-described, has the following advantage.

(1) In the second embodiment, the controller 50 generates the lift information LI, in accordance with which the lift mechanisms 24 are operated, based on the substrate position information HI. In drying of the droplets Fb, the lift mechanisms 24 maintain the mirror gap MG and the platen gap PG at the radiation gap MG1 and the ejection gap PG1, respectively.

Therefore, while maintaining the position of the reflective mirror 33 relative to the position of the ejection head 31, the mirror gap MG is set to a value smaller than the platen gap PG. This increases the drying time of the droplets Fb and thus reliably suppresses defects of formation of the dots D, as in the first embodiment.

The illustrated embodiments may be modified in the following forms.

In the first and second embodiments, the ejection gap PG1 and the radiation gap MG1 are set to 300 μm and 100 μm, respectively. However, as long as the accuracy of receiving the droplets Fb is ensured, the ejection gap PG1 may be set to any other suitable value. The radiation gap MG1 may also be set to any suitable value as long as the value is smaller than the ejection gap PG1.

In the first and second embodiments, the optical member is embodied by the right angle prism mirror. However, the present invention is not restricted to this and the optical member may be embodied by a galvanic mirror. Alternatively, the radiating direction of the laser beam L2 radiated by the semiconductor laser LD may be substantially the same as the direction defined by the incident angle θi. In this case, the optical member is embodied by a cylindrical lens. In other words, the optical member may be formed by any suitable component, as long as the radiating direction of a laser beam radiated onto droplets becomes substantially the same as the movement direction (the scanning direction) of a substrate and the laser beam is sent from a laser source to an area on the substrate opposed to a nozzle plate.

In the first and second embodiments, the transport device is embodied by the stage 23. However, the present invention is not restricted to this and the transport device may be embodied by the carriage 30. That is, the transport device may be any suitable component as long as the transport device moves at least one of a substrate and a nozzle plate relative to the other along one direction.

In the first and second embodiments, the second shifting device is embodied by the lift mechanisms 24. However, other than these, a second shifting device that moves the ejection head 31 toward or separately from the substrate may be provided. In other words, the second shifting device may be any suitable device as long as the device shifts at least one of a substrate and an ejection head.

In the first and second embodiments, the bit map data BMD is generated in accordance with the marking information Ia. However, the present invention is not restricted to this. That is, the bit map data BMD may be generated in advance by an external device and input to the controller 50 through the input device 51.

In the first and second embodiments, the droplet ejection head is embodied by the piezoelectric element drive type ejection head 31. However, other than this, the droplet ejection head may be embodied by an ejection head of a resistance heating type or an electrostatically driven type.

In the first and second embodiments, the beam spot BS is formed commonly for the multiple droplets Fb that have been received by the substrate 2. However, the present invention is not restricted to this. That is, for example, the laser beam L2 radiated by the semiconductor laser LD may be divided in correspondence with the nozzles N. In this case, beam spots are formed in correspondence with the received droplets Fb.

In the first and second embodiments, the mark forming material is embodied by the metal ink F. However, other than this, the mark forming material may be embodied by, for example, a liquefied material containing insulating film forming material or organic material. That is, the mark forming material may be any suitable material as long as the material is dried by a laser beam and forms a mark of solid phase.

In the first and second embodiments, the semispherical dots D are formed by drying the droplets Fb. However, the present invention is not restricted to this. That is, for example, flat or oval shaped dots may be formed by drying droplets.

In the first and second embodiments, the mark is embodied by the identification code 10 formed on the glass substrate 2. However, other than this, the mark may be formed by metal trace pattern or an insulating film formed on the glass substrate 2 or on a multilayer wiring substrate. In other words, the mark may include any suitable object as long as the mark is formed by drying droplets.

In the first and second embodiments, the identification code 10 (the mark) is formed on the liquid crystal display 1. However, other than this, the mark may be formed on an organic electroluminescence display. Alternatively, the mark may be formed on an electric field effect type display (such as an FED or an SED) having a flat electron release element.

The present examples and embodiments are to be considered as illustrative and not restrictive and the invention is not to be limited to the details given herein, but may be modified within the scope and equivalence of the appended claims.

1. A droplet ejection apparatus that ejects liquid droplets containing a mark forming material onto a substrate, the apparatus comprising:
a droplet ejection head having a nozzle plate opposed to the substrate, the droplets being ejected from nozzles of the nozzle plate;
a transport device that transports at least one of the substrate and the droplet ejection head relative to the other along one direction;
a laser source that radiates a laser beam for drying the droplets on the substrate;
an optical member provided in the droplet ejection head, wherein the optical member guides the laser beam of the laser source onto an area on the substrate opposed to the nozzle plate in such a manner that the radiating direction of the laser beam with respect to the droplets becomes substantially parallel with the one direction as viewed in a normal direction of the substrate; and
a first shifting device that shifts at least one of the optical member and the substrate in such a manner that the distance between an optical surface of the optical member and the substrate becomes shorter than the distance between the nozzle plate and the substrate.

2. The apparatus according to claim 1, further comprising:
a distance information generating section that detects the distance between the nozzle plate and the substrate and generates a distance information regarding the detected distance; and
a second shifting device that shifts at least one of the droplet ejection head and the substrate in accordance with the distance information in such a manner that the distance between the nozzle plate and the substrate becomes a predetermined reference value,
wherein the first shifting device shifts at least one of the optical member and the substrate in such a manner that the distance between the optical surface of the optical member and the substrate becomes shorter than the reference value.

3. The apparatus according to claim 1, further comprising:
a distance information generating section that detects the distance between the nozzle plate and the substrate and generates a distance information regarding the detected distance;
a shifting information generating section that generates a shifting information used for shifting at least one of the optical member and the substrate in accordance with the distance information in such a manner that the distance between the optical surface of the optical member and the substrate becomes shorter than the distance between the nozzle plate and the substrate; and
a control section that controls operation of the first shifting device in accordance with the shifting information.

4. The apparatus according to claim 1, wherein the optical member is a reflective mirror that reflects the laser beam of the laser source and guides the laser beam onto an area corresponding to the droplets opposed to the nozzle plate.

5. The apparatus according to claim 1, wherein the laser source is a semiconductor laser.

6. The apparatus according to claim 1, wherein the mark forming material is an ink containing metal particles.

7. An identification code formed by a plurality of dots provided on a surface of a substrate using the droplet ejection apparatus according to any one of claims 1 to 6.

8. A method for forming a mark on a substrate by ejecting liquid droplets containing a mark forming material onto the substrate, the method comprising:
ejecting the droplets onto the substrate through nozzles defined in a nozzle plate of a droplet ejection head while moving at least one of the substrate and the droplet ejection head relative to the other along one direction;
drying the droplets by radiating a laser beam onto the droplets on the substrate;
guiding the laser beam onto an area on the substrate opposed to the nozzle plate by means of an optical member in such a manner that the radiating direction of the laser beam with respect to the droplets becomes substantially parallel with the one direction as viewed in a normal direction of the substrate; and
shifting at least one of the optical member and the substrate in such a manner that the distance between an optical surface of the optical member and the substrate becomes shorter than the distance between the nozzle plate and the substrate.
